(19) United States
(12) Patent Application Publication
(10) Pub. No.: US 2025/0371348 A1
(43) Pub. Date: Dec. 4, 2025

(54) TEXT-TO-IMAGE MODEL TRAINING METHOD AND APPARATUS, DEVICE, AND STORAGE MEDIUM

(71) Applicant: Tencent Technology (Shenzhen) Company Limited, Shenzhen (CN)

(72) Inventors: Cong XIE, Shenzhen (CN); Jianxiang LU, Shenzhen (CN); Hui GUO, Shenzhen (CN)

(73) Assignee: Tencent Technology (Shenzhen) Company Limited, Shenzhen (CN)

(21) Appl. No.: 19/302,190

(22) Filed: Aug. 18, 2025

Related U.S. Application Data
(63) Continuation of application No. PCT/CN2024/098329, filed on Jun. 11, 2024.

(30) Foreign Application Priority Data
Aug. 17, 2023 (CN) 202311044371.5

(51) Int. Cl. G06N 3/08; G06N 3/04; G06T 11/00

(52) U.S. Cl. CPC G06N 3/08; G06N 3/04; G06T 11/00

(57) ABSTRACT

A text-to-image model training method, apparatus, and computer-readable storage medium for enhancing text-to-image generation through object-aware training. The method trains a text-to-image model using cyclic iterative training with sample image and text pairs. Training involves selecting image-text sample pairs containing multiple objects, obtaining corresponding mask images and object class names that distinguish location regions of the objects, and inputting both the sample image with description text and the mask images with object class names into the model. The method obtains image predicted noise and object predicted noises, constructs a loss function based on these predictions, and performs parameter adjustment accordingly. This approach enables improved object-level understanding in text-to-image generation models.

### CROSS-REFERENCE TO RELATED APPLICATIONS

This application is a continuation application of International Application No. PCT/CN2024/098329 filed on Jun. 11, 2024 which claims priority to Chinese Patent Application No. 202311044371.5, filed with the China National Intellectual Property Administration on Aug. 17, 2023, the disclosures of each being incorporated by reference herein in their entireties.

### FIELD

The disclosure relates to the field of artificial intelligence technologies, and a text-to-image model training technology.

### BACKGROUND

In the long-term development of Artificial Intelligence (AI), a text-to-image model has been significantly improved. The text-to-image model can implement high-quality and diversified image output based on a given text prompt. However, for accuracy of an output of the text-to-image model, the text-to-image model may be further fine-tuned.

In the related art, manners of performing fine tuning on the text-to-image model at least include: manner 1: performing fine tuning on the text-to-image model based on an image and an object concept; and manner 2: performing fine tuning on the text-to-image model based on a prompt word obtained after an object concept image is converted.

However, regardless of the manner 1 or the manner 2, when the text-to-image model is fine-tuned, the text-to-image model may focus on embedding of a single object, while complexity of a multi-object scenario is ignored. In addition, in a fine-tuning process, a used training sample includes complex background information, which may interfere with model training, causing inaccurate training of the text-to-image model.

Therefore, how to obtain an accurate text-to-image model in the multi-object scenario is a technical problem to be resolved.

### SUMMARY

Provided are a text-to-image model training method and apparatus, a device, a storage medium, and a program product, which can implement enhanced text-to-image generation through object-aware training using mask images and object class information.

According to some embodiments, a text-to-image model training method, performed by a computing device, comprises training a text-to-image model by performing cyclic iterative training using a training set comprising sample image and text pairs, wherein the cyclic iterative training comprises: selecting an image-text sample pair from the training set, the image-text sample pair comprising a sample image and description text of the sample image, and the sample image including at least two objects; obtaining at least two mask images and at least two object class names corresponding to the at least two objects, the mask images being configured to distinguish location regions of the at least two objects; inputting the sample image and the description text into the text-to-image model to obtain an image predicted noise of the sample image; inputting the at least two mask images and the at least two object class names into the text-to-image model to obtain at least two object predicted noises corresponding to the mask images; constructing a loss function based on the image predicted noise and the at least two object predicted noises; and performing parameter adjustment on the text-to-image model based on the loss function.

According to some embodiments, a text-to-image model training apparatus, includes: at least one memory configured to store program code; and at least one processor configured to read the program code and operate as instructed by the program code, the program code including: training code configured to cause at least one of the at least one processor to train a text-to-image model by performing cyclic iterative training using a training set comprising sample image and text pairs, wherein the cyclic iterative training comprises: selecting code configured to cause at least one of the at least one processor to select an image-text sample pair from the training set, the image-text sample pair comprising a sample image and description text of the sample image, and the sample image including at least two objects; obtaining code configured to cause at least one of the at least one processor to obtain at least two mask images and at least two object class names corresponding to the at least two objects, the mask images being configured to distinguish location regions of the at least two objects; input code configured to cause at least one of the at least one processor to input the sample image and the description text into the text-to-image model to obtain an image predicted noise of the sample image; mask code configured to cause at least one of the at least one processor to input the at least two mask images and the at least two object class names into the text-to-image model to obtain at least two object predicted noises corresponding to the mask images; construction code configured to cause at least one of the at least one processor to construct a loss function based on the image predicted noise and the at least two object predicted noises; and adjustment code configured to cause at least one of the at least one processor to perform parameter adjustment on the text-to-image model based on the loss function.

According to some embodiments, a non-transitory computer-readable storage medium, storing computer code which, when executed by at least one processor, causes the at least one processor to at least: train a text-to-image model by performing cyclic iterative training using a training set comprising sample image and text pairs, wherein the cyclic iterative training comprises: select an image-text sample pair from the training set, the image-text sample pair comprising a sample image and description text of the sample image, and the sample image including at least two objects; obtain at least two mask images and at least two object class names corresponding to the at least two objects, the mask images being configured to distinguish location regions of the at least two objects; input the sample image and the description text into the text-to-image model to obtain an image predicted noise of the sample image; input the at least two mask images and the at least two object class names into the text-to-image model to obtain at least two object predicted noises corresponding to the mask images; construct a loss function based on the image predicted noise and the at least two object predicted noises; and perform parameter adjustment on the text-to-image model based on the loss function.

### BRIEF DESCRIPTION OF THE DRAWINGS

To describe the technical solutions in some embodiments more clearly, the following briefly describes the accompanying drawings required for describing embodiments. Apparently, the accompanying drawings in the following description show merely some embodiments of this application, and a person of ordinary skill in the art may still derive other drawings from these accompanying drawings without creative efforts.

FIG. 1 is a schematic diagram of an application scenario according to some embodiments.

FIG. 2 is a schematic structural diagram of a text-to-image model according to some embodiments.

FIG. 3 is a schematic diagram of a denoising network according to some embodiments.

FIG. 4 is a schematic structural diagram of a text-to-image model according to some embodiments.

FIG. 5 is a schematic diagram of determining a mask image by object marking according to some embodiments.

FIG. 6 is a schematic flowchart of a text-to-image model training method according to some embodiments.

FIG. 7 is a schematic diagram of noise prediction according to some embodiments.

FIG. 8 is a schematic diagram of text-to-image model training according to some embodiments.

FIG. 9 is a method flowchart of image generation according to some embodiments.

FIG. 10 is a schematic diagram of image generation based on a text-to-image model according to some embodiments.

FIG. 11 is a schematic diagram of image generation based on a text-to-image model according to some embodiments.

FIG. 12 is a structural diagram of a training apparatus of a text-to-image model according to some embodiments.

FIG. 13 is a structural diagram of a computing device according to some embodiments.

### DESCRIPTION OF EMBODIMENTS

To make the objectives, technical solutions, and beneficial effects of this application clearer, the following clearly and completely describes the technical solutions in some embodiments with reference to the accompanying drawings in some embodiments. Apparently, the described embodiments are merely some rather than all embodiments of this application. All other embodiments obtained by a person of ordinary skill in the art based on embodiments of this application without creative efforts fall within the scope of protection of this application.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Some terms in some embodiments are described below for ease of understanding by a person skilled in the art.

A text-to-image model, also referred to as a text-to-image diffusion model, is a deep learning model, and is used for a text-to-image task. The text-to-image model may, after reversal training of a natural image diffusion process, under text guidance, gradually generate a new natural image from a completely random noise image. The noise image is generated after being interfered with by a random signal during photographing or transmission, and is presented as a random change in image information or pixel brightness.

A variational autoencoder (VAE) is a probabilistic model based on variational inference, and is a generative model. An architecture design thereof includes an encoder and a decoder.

The encoder is configured to map original high-dimensional data to a low-dimensional feature space. A dimension of this feature is generally smaller than an original data dimension, and performs compression or dimensionality reduction. This low-dimensional feature usually also becomes a latent representation. The decoder is configured to reconstruct the original data based on the compressed low-dimensional feature.

A mask image has the same size as an original image, and is configured for distinguishing a location region of an object in the original image. The mask image includes only 0 or 1, and 1 represents a part of a region of interest or represents a part of an object region.

A low-rank adaptation (LoRA) weight is low-rank adaptation of a large language model. The LoRA freezes a weight of a pre-trained model, and injects a trainable rank decomposition matrix to each layer of a transformer architecture, greatly reducing a quantity of trainable parameters of downstream tasks. In some embodiments, the LoRA mainly injects a trainable network parameter into a denoising network in a text-to-image model. A denoising network layer is configured to associate an image with description text, and the LoRA weight affects a network parameter corresponding to the denoising network layer, for example, a weight matrix part of the denoising network layer.

Fine tuning is to train some tasks in a customized manner by using a pre-trained model, and modify a network for a task. A to-be-trained model in some embodiments is a pre-trained model. After parameter adjustment is performed by using the method in some embodiments, a text-to-image model may be obtained, to implement a task of generating an image based on a text condition.

Terms “exemplary”, “exemplarily”, and “for example” used in the following means “used as an example, an embodiment, or a description”. Any embodiment described as “exemplary”, “exemplarily”, and “for example” is not necessarily construed as being superior to or better than another embodiment.

Terms “first” and “second” herein are merely used for description, and cannot be construed as indicating or implying relative importance or implicitly indicating a quantity of indicated technical features. Therefore, a feature defined to be “first” or “second” may explicitly or implicitly include one or more features. In the description of some embodiments, unless otherwise stated, “a plurality of” refers to two or more.

In the long-term development of Artificial Intelligence (AI), a text-to-image model has been significantly improved. The text-to-image model can implement high-quality and diversified image output based on a given text prompt. However, for accuracy of an output of the text-to-image model, the text-to-image model may be further fine-tuned.

Currently, manners of performing fine tuning on the text-to-image model at least include: manner 1: performing fine tuning on the text-to-image model based on a provided image and object concept by using a DreamBooth; and manner 2: performing fine tuning on the text-to-image model based on a provided object concept image by using textual inversion.

When the DreamBooth is used to perform fine tuning on the provided image and object concept in the text-to-image model (for example, a stable diffusion (SD) open source model), several images and text “a [V] [class name]” of these images are given, where [class name] is an object class name, and [V] is a special identifier. After fine tuning, a text-to-image diffusion model including [V] bound to a given object is obtained. In an inference stage, an image may be generated by using the special identifier.

By using textual inversion, three to five provided object concept images are used. These concepts are represented by learning pseudo-words in a text embeddings space of the text-to-image model, and these pseudo-words are combined into a sentence of a natural language, to guide generation of a new object.

However, regardless of the manner 1 or the manner 2, when the text-to-image model is fine-tuned, the text-to-image model focuses on embedding of a single object, while complexity of a multi-object scenario is ignored. In addition, in a fine-tuning process, a used training sample includes complex background information, which may interfere with model training, causing inaccurate training of the text-to-image model.

Therefore, in the related technology, in a process of training a text-to-image model, the following disadvantages are included:

Single-object embedding limitation: focusing on embedding of only a single object, ignoring complexity of a multi-object scenario, and limiting a generation capability of the text-to-image model in embedding multiple objects.

Training sample background interference: If a training sample includes complex background information, the training sample may cause interference to learning of the text-to-image model, and the text-to-image model may mistakenly consider details in a background as a part of an object, causing inaccurate training of the text-to-image model, and further causing blurry boundaries between the object and the background in an image generated based on the text-to-image model.

In conclusion, how to obtain an accurate text-to-image model in the multi-object scenario is a current technical problem to be resolved.

In view of this, embodiments of this application provide a text-to-image model training method and apparatus, a device, and a storage medium. Considering that a text-to-image model in the related technology is only applicable to embedding a single object in an image, complexity of a multi-object scenario is ignored, and a generation capability of the text-to-image model in embedding multiple objects in an image is limited. Therefore, embodiments of this application provide a text-to-image model training method applicable to the multi-object scenario. To ensure model training accuracy, cyclic iterative training is performed on a to-be-trained model based on an image-text sample pair training set, to obtain a text-to-image model.

In a training process, input information inputted into the to-be-trained model is first obtained. Specifically, an image-text sample pair is selected from the image-text sample pair training set, the image-text sample pair includes a sample image and description text. As the text-to-image model is trained for the multi-object scenario, to enable the text-to-image model to process the complex multi-object scenario and improve a multi-object generation capability, it may be ensured that the sample image includes at least two objects. In addition, considering that in addition to the at least two objects, the sample image further includes complex background information, the background information interferes with model training, making the model training inaccurate; and considering that when the at least two objects exist in the sample image, an accurate correspondence between an object and text is also a main factor for accurate model training; Therefore, after the image-text sample pair is selected, mask images and associated object class names respectively corresponding to the at least two objects in the sample image are obtained. The mask images are configured for distinguishing location regions of the objects in the sample image, to distinguish the objects from a background, prevent the background information from interfering with the model training, and obtain a correspondence between the mask images and the object class names, helping to enhance an object relationship between the objects and the text. In this way, in a model training process, a text description can be better understood and accurately mapped to a responding object, thereby ensuring accuracy of the text-to-image model. Therefore, in addition to the sample image and the description text, the input information further includes the mask images and the associated object class names.

After the input information is obtained, the input information is inputted into the to-be-trained model, and a model parameter is adjusted based on a text-to-image output result. Specifically, the sample image and the description text are first inputted into the to-be-trained model, to obtain an image predicted noise of the sample image; the at least two mask images and the associated object class names are inputted into the to-be-trained model, to obtain object predicted noises respectively associated with the at least two mask images; a loss function is constructed based on the image predicted noise and at least two object predicted noises; and finally, parameter adjustment is performed on the to-be-trained model by using the constructed loss function. In some embodiments, a multi-object local region is referenced to add a loss, the loss can separate the objects from another region, so that the model pays more attention to details and boundaries of the object, thereby reducing an impact of background interference on the to-be-trained model, improving accuracy of the text-to-image model in the multi-object scenario, and further improving consistency and accuracy of generating an image based on the to-be-trained model.

Embodiments of this application relate to artificial intelligence (AI) and machine learning technologies, and are designed based on a voice technology, a natural language processing technology, and machine learning (ML) in artificial intelligence.

Application scenarios set by this application are briefly described in the following. The following scenarios are only used to illustrate, but not limit, embodiments of this application. In implementation, the technical solutions provided in some embodiments can be flexibly applied according to actual needs.

Referring to FIG. 1, FIG. 1 is a schematic diagram of an application scenario according to some embodiments. The application scenario includes a terminal device 110 and a server 120. The terminal device 110 can communicate with the server 120 through a communication network.

In some embodiments, the communication network may be a wired network or a wireless network. Therefore, the terminal device 110 and the server 120 may be directly or indirectly connected in a wired or wireless communication mode. For example, the terminal device 110 may be indirectly connected to the server 120 by using a wireless access point, or the terminal device 110 may be directly connected to the server 120 by using the Internet. This is not limited in this application herein.

The terminal device 110 includes, but is not limited to, devices such as a mobile phone, a tablet computer, a notebook computer, a desktop computer, an e-book reader, an intelligent voice interaction device, a smart home appliance, and an in-vehicle terminal. Various clients may be installed on the terminal device. The clients may be an online platform or an application program that supports text input and an image generation function based on inputted text, or may be a web page, a mini program, or the like. In other words, the clients support application of the text-to-image model. For example, a client is an intelligent creation system. The intelligent creation system supports the application of the text-to-image model, and may provide a personalized image customization function for a user by using the text-to-image model.

When the intelligent creation system provides the personalized image customization function for the user by using the text-to-image model, the user may first upload an image and mark objects in the image, to obtain mask images of the objects; and also may set an object class name of an object associated with each mask image, to further instruct the intelligent creation system to customize an image. For example:

An interior design and home furnishing customization scenario: The user may upload a photograph of an interior space, and precisely specify an object such as furniture or a decoration by using a mask image of the object and an associated object class name. The intelligent creation system generates a personalized interior design solution according to a requirement and a style preference of the user, to help the user customize home furnishing.

A fashion styling and clothes design scenario: The user may upload a photograph, and specify an object such as clothes or an accessory by using a mask image of the object and an associated object class name. The system provides a personalized fashion styling suggestion based on information such as a figure and a style preference of the user, to help the user with clothes design and styling.

An advertising creation and brand customization scenario: By using this technology, an advertising company or a brand may provide personalized advertising creation and brand customization services for customers of the advertising company or the brand. During use, an image related to a brand of the user is uploaded, and a product or an element that may be highlighted is specified by using a mask image of an object and an associated object class name, to generate a customized advertisement material consistent with a brand image, helping the brand improve a promotion effect and brand recognition.

A gift customization and personalized product customization scenario: The user may upload a image, and specify, by using a mask image of an object and an associated object class name, a element of a gift or a product that needs personalized customization. The intelligent creation system generates a personalized gift customization solution based on a designation of the user, to help the user make a unique gift or a personalized product.

Therefore, using the text-to-image model provided in some embodiments, personalized image customization can be implemented based on a provided image, a mask image of an object, and an associated object class name, to satisfy creation requirements and customization requirements in various scenarios.

The server 120 is a backend server corresponding to a client installed in the terminal device 110. The server may provide a background service function of the intelligent creation system, for example, implement the text-to-image model training method and operations of generating an image based on the text-to-image model provided in some embodiments. The server 120 may be an independent physical server, or may be a server cluster or a distributed system formed by a plurality of physical servers, or may be a cloud server that provides cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

In a possible application scenario, the terminal device obtains an image and text information, and transmits the image and the text information to the server. The server generates an image based on the text-to-image model, then delivers the generated image to the terminal device, and the generated image is presented to the user through the terminal device.

In a possible application scenario, related data (such as an image-text sample pair) and a model parameter involved in some embodiments may be stored by using a cloud storage technology. Cloud storage is a new concept extended and developed from a cloud computing concept. A distributed cloud storage system refers to a storage system that aggregates, by using functions such as a cluster application, a mesh technology, and a distributed file storage system, and by using application software or an application interface, a large quantity of storage devices (or are referred to as storage nodes) of different types in a network to work together, to jointly provide data storage and service access functions to the outside.

FIG. 1 is merely an example, and actual quantities of the terminal devices 110 and the servers 120 are not limited, and are not limited in some embodiments. In some embodiments, when there are a plurality of servers 120, the plurality of servers 120 may form a blockchain, and the servers 120 are nodes on the blockchain.

The text-to-image model training method in some embodiments may be performed by a computing device, and the computing device may be the server 120 or the terminal device 110. In other words, the method may be performed by the server 120 or the terminal device 110 alone, or may be performed by the server 120 and the terminal device 110 together.

To further describe the technical solutions provided in some embodiments, by using an example in which the server performs the method alone, and with reference to the accompanying drawings, the text-to-image model training method and the application of the text-to-image model provided in exemplary implementations of this application are described in the following. The above application scenarios are only for facilitating the understanding of the spirit and principle of this application, and are not intended to limit the implementations of this application. In addition, although the operations of the method in this application are described in a order in the accompanying drawings, this does not require or imply that the operations have to be performed in the order, or all the operations shown have to be performed to achieve an expected result. Additionally or alternatively, some operations may be omitted, a plurality of operations may be combined into one operation, and/or one operation may be decomposed into a plurality of operations for execution.

To enable the text-to-image model to be applied to a multi-object scenario, and ensure accuracy of the text-to-image model in the multi-object scenario, embodiments of this application provide a text-to-image model training method. In addition, to verify consistency and accuracy of images generated based on the text-to-image model, in some embodiments, after the text-to-image model is obtained, a model application method is provided. Specifically, the text-to-image model is used in combination with specified text including at least two target class names, to generate an image associated with the specified text.

An overall implementation of embodiments of this application is described in the following respectively from a model training process and a model application process.

### Embodiment 1: Model Training Process

In some embodiments, a training process is a cyclic iterative training process on a to-be-trained model for a plurality of times by using a training sample. The training process may mainly include a model design stage, a data preparation stage, and an iterative training stage. Stages are separately described in the following.

### 1. Model Design Stage

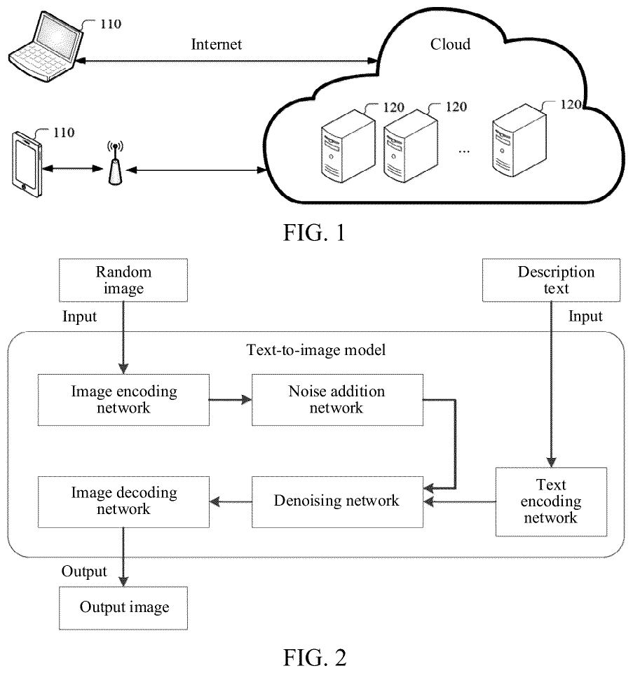

Referring to FIG. 2, FIG. 2 is a schematic structural diagram of a text-to-image model according to some embodiments. The text-to-image model includes: a noise addition network, a denoising network, a text encoding network, an image encoding network, and an image decoding network.

The image encoding network is configured to perform image encoding on an obtained random image (also referred to as a random seed), to obtain a corresponding image feature. In a possible implementation, the image encoding network may use, but is not limited to, a variational autoencoder (VAE). The VAE maps the random image to a latent feature space, to obtain the corresponding image feature.

The noise addition network is configured to perform diffusion and noise addition on the image feature, to obtain a corresponding noise-added image feature. In a possible implementation, the noise addition network randomly adds a Gaussian feature to the image feature. A process may be a fixed Markov chain process, where original data distribution is changed to normal distribution by continuously adding Gaussian noises.

The text encoding network is configured to perform text encoding on obtained description text (which may be a group of keywords and is referred to as multi-tag information), to obtain a corresponding text feature. In a possible implementation, the text encoding network may use, but is not limited to, a contrastive language-image pre-training (CLIP) model.

The denoising network is configured to perform denoising processing on the obtained noise-added image feature based on the obtained text feature, to obtain a denoised image feature. In a possible implementation, the denoising network converts the Gaussian noises into known data distribution content through an iterative denoising process, for example, restores data from the normal distribution to the original data distribution by using a neural network, so that a generated image has good diversity and reality.

In a possible implementation, the denoising network may use, but is not limited to, a U-Net network. The U-Net network is an encoding-decoding structure, and the U-Net network may use, but is not limited to, an attention mechanism implementation.

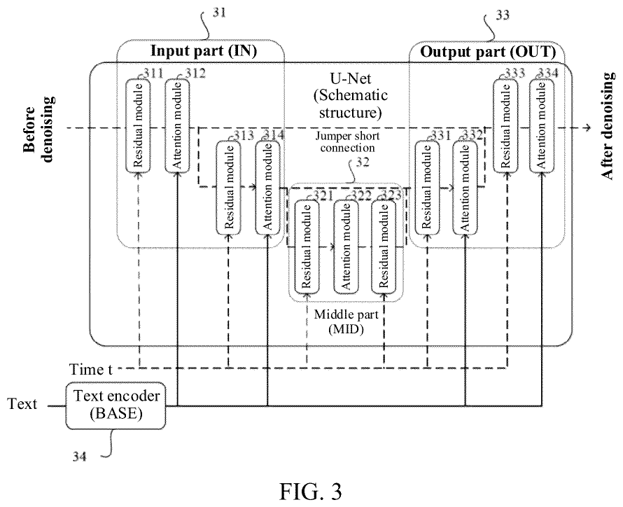

Referring to FIG. 3, FIG. 3 is a schematic diagram of a denoising network according to some embodiments. Exemplarily, the denoising network is a U-Net network. The U-Net network includes a plurality of cross-attention (QKV) modules (also referred to as cross-attention layers), and a cross-attention (QKV) module included in the U-Net network may also be named, based on a function of the network, a denoising network layer. The denoising network layer is configured to model a relationship between text and an image, and perform denoising processing on the image by using the text as a condition.

FIG. 3 lists structures of different layers of the U-Net network, and FIG. 3 only shows a part due to space limitations. Based on FIG. 3, the denoising network layer is divided into three parts: an input part (IN) 31, a middle part (MID) 32, and an output part (OUT) 33. In addition, a text encoder (BASE) 34 is further added.

Except the text encoder (BASE), the input part (IN), the middle part (MID), and the output part (OUT) may all be understood as denoising network layers in the text-to-image model.

As shown in FIG. 3, the input part 31 simply shows only four layers, which are respectively a residual module 311, an attention module 312, a residual module 313, and an attention module 314. The middle part 32 simply shows only three layers, which are respectively a residual module 321, an attention module 322, and a residual module 323. The output part 33 simply shows only four layers, which are respectively a residual module 331, an attention module 332, a residual module 333, and an attention module 334. The U-Net structure listed in FIG. 3 is only a simple example.

The U-Net network may further include a skip connection structure, and each downsampling may include a skip connection cascaded with corresponding upsampling. In this way, the U-Net network, in each upsampling, fuses features of the encoder at a corresponding position on a channel, and fuses features of different sizes to improve detection precision.

The image decoding network is configured to decode the obtained denoised image feature, to obtain a predicted image corresponding to a group of keywords, for example, to obtain an output image.

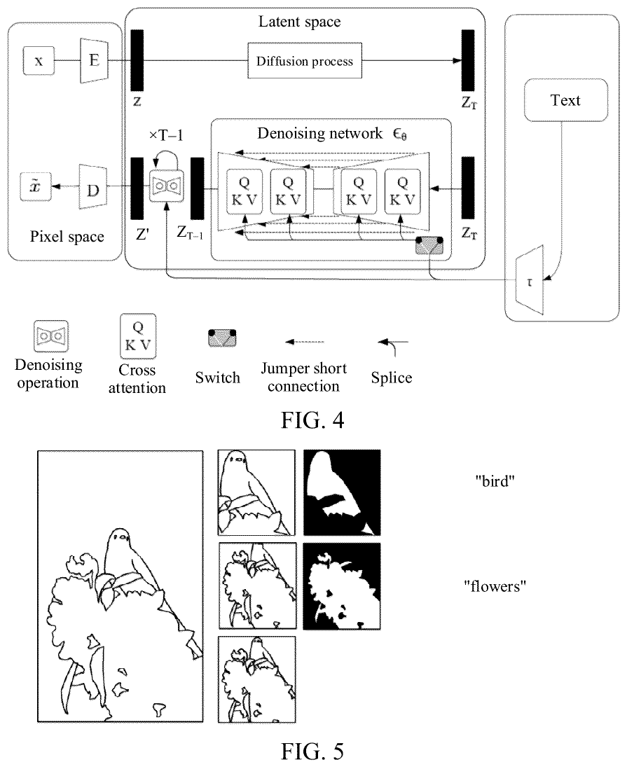

Referring to FIG. 4, FIG. 4 is a schematic structural diagram of a text-to-image model according to some embodiments. As shown in FIG. 4, for a random image x, an image feature (Z) is obtained by using an image encoding network (E). Then, diffusion and noise addition are performed on the image feature (Z) by using a noise addition network, and the image feature (Z) is projected into a hidden space to obtain a hidden space vector, for example, a noise image feature (Z_{T}). In addition, a text feature is obtained by using a text encoding network (τ) based on description text. Then, the text feature and the noise image feature (Z_{T}) are inputted into a denoising network, and denoising prediction is performed on the noise image feature (Z_{T}) by using the denoising network under a constraint of the text feature for T times, to finally generate a hidden space predicted vector (Z′), for example, generate a predicted image feature. Finally, the hidden space predicted vector (Z′) is decoded by using an image decoding network (D), to output an image (\tilde{x}), where the image (\tilde{x}) is a predicted image.

In the noise addition network, the noise image feature (Z_{T}) is generated through T times of diffusion based on the image feature (Z), and Z_{T} represents a hidden space value at a moment T. Correspondingly, in the denoising network, the denoising prediction is performed on the noise image feature (Z_{T}) for T times through a denoising process, to obtain the predicted image feature (Z′). A first denoising process is used as an example: The text feature is used as KV in a QKV module, the noise image feature (Z_{T}) is used as Q in the QKV module, and the text feature is configured to constrain denoising of the noise-added image feature (Z_{T}), so that after denoising for T times, the QKV module outputs the predicted image feature (Z′) related to the inputted description text.

FIG. 4 shows only one possible layer relationship, and in an actual application process, a quantity and a connection relationship of the QKV modules may both be designed based on an actual situation.

In some embodiments, a VAE encoded feature of the random image is mapped to hidden space representation at the moment T by using a diffusion network, and subsequently, noise representation fitting (for example, the image predicted noise) is learned by using the denoising network. In this way, the image predicted noise is subtracted, to obtain image representation that is really needed, and further obtain the predicted image by using a decoder.

### 2. Data Preparation Stage

Data collection is of great importance in machine learning, and may be the most important part. The data preparation stage in some embodiments mainly includes: a preparation process of an image-text sample pair, and an object marking process in a sample image of the image-text sample pair.

A preparation process of an image-text sample pair:

The image-text sample pair may be a pair of samples consisting of a sample image and description text describing the sample image. The sample image may be an image used as a sample to train the text-to-image model, and the description text corresponding to the sample image is text used to describe content of the sample image. In a possible implementation, the sample image and the corresponding description text in the image-text sample pair are uploaded by a user, where the sample image includes at least two objects.

In another possible implementation, the image-text sample pair targets an application scenario, and obtains each candidate image and associated description text in the application scenario. The application scenario may be generating a corresponding film and television show poster based on specified text. In this case, the film and television show poster is the sample image in the image-text sample pair, and the specified text is the description text in the image-text sample pair. The application scenario may alternatively be generating a corresponding short video cover, an article cover, or the like, based on specified text.

Object marking process:

Each object in the sample image is marked, and a mask image corresponding to each object is generated. The mask image may be an image displaying only an outline of a corresponding object, and is configured for distinguishing location regions of corresponding objects in the sample image. In a possible implementation, object marking may be manually drawn, or may be generated by using an automatic marking algorithm.

When each object in the sample image is marked, an object class name is further set for the object. Therefore, a corresponding relationship between the mask image of the object and the object class name can be determined.

Referring to FIG. 5, FIG. 5 is a schematic diagram of determining a mask image by object marking according to some embodiments.

FIG. 5 exemplarily uses a sample image including a “flower” and a “bird” as an example. First, the “flower” and the “bird” are respectively marked, and respective locations of the “flower” and the “bird” in the image are determined. Then, a mask image of the “flower” and a mask image of the “bird” are determined, where the mask image of the “flower” only displays a schematic outline of the “flower”, to determine a location region of the “flower” in the sample image; and the mask image of the “bird” only displays a schematic outline of the “bird”, to determine a location region of the “bird” in the sample image. Finally, the mask image and the object class name of each object are determined.

In this way, in some embodiments, except the image-text sample pair, sample data further includes a mask image and an object class name associated with each object in the sample image. Based on setting the mask image, details and boundaries of objects can be distinguished, thereby reducing background interference and improving model training accuracy.

### 3. Iterative Training Stage

In some embodiments, cyclic iterative training is performed on the to-be-trained model, to obtain the text-to-image model. The cyclic iterative training is a technology in a process of machine learning, deep learning, or other algorithm optimization. A core idea thereof is to continuously improve performance of a model by repeatedly performing a process or algorithm, until a predetermined condition is satisfied or a predetermined number of iteration times is reached. In a model training process, cyclic iteration is performed on a full image-text sample pair (for example, an image-text sample pair training set) for a total of a plurality of rounds (for example, 100 rounds). All of the full image-text sample pair being trained in the to-be-trained model for once is referred to as a round of iteration. In each round of iteration, as video memory resources of a training machine are limited, the full sample pair cannot be inputted into the model at a time for training. Therefore, batch training may be performed on all sample pairs. Each batch of samples is generated in a manner such as random division, and each batch of samples is inputted into the model for training such as forward calculation, backward calculation, and model parameter update.

In a possible implementation, first, an image-text sample pair is selected from an image-text sample pair training set, and based on a sample image in the image-text sample pair, mask images and associated object class names of at least two objects in the sample image are obtained. Then, the image-text sample pair and a correspondence relationship between the mask images of the objects and object classes are used as a training input, to perform cyclic iterative training on the to-be-trained model in a multi-object embedding scenario for a plurality of times. In each cyclic iterative process, a text encoding network in the to-be-trained model and a LoRA module of a CrossAttention linear layer in the cross-attention (QKV) module on the denoising network are adjusted based on a loss, to obtain text embedding and a LoRA weight of each object, and a trained text-to-image model is determined based on the text embedding and the LoRA weight of the object. In this way, the model can process a complex multi-object scenario, and a multi-object generation capability is improved.

Before the first round of training, a parameter of the to-be-trained model may be initialized. Specifically, a model parameter of a corresponding pre-trained model is used for a model parameter (such as a model parameter respectively included in an image encoding network, a noise addition network, a text encoding network, a denoising network, and an image decoding network) that does not may be adjusted. In addition, during each round of training, the model parameter is continuously updated, and a LoRA weight injected to a network is randomly initialized. Further, hyperparameters such as a batch, a quantity of iteration times (an epoch), and a learning rate are separately set. After the settings are completed, training is started, to obtain the text-to-image model. The learning rate is set to 1e⁻⁴.

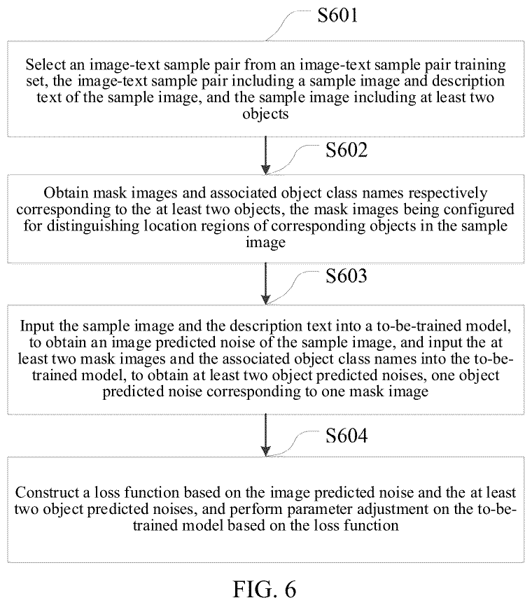

As operations performed in each round of cyclic iteration are consistent, training of the to-be-trained model is described by using one round of cyclic iteration as an example. As shown in FIG. 6, a schematic flowchart of a text-to-image model training method according to some embodiments is shown, including the following operations:

Operation S601: Select an image-text sample pair from the image-text sample pair training set, the image-text sample pair including a sample image and description text of the sample image, and the sample image including at least two objects.

The image-text sample pair training set may be a set formed by a plurality of image-text sample pairs, and is configured to train a text-to-image model.

Operation S602: Obtain mask images and associated object class names respectively corresponding to the at least two objects, the mask images being configured for distinguishing location regions of corresponding objects in the sample image.

An object class name may be a tag or a name used for identifying a object in

the sample image, and the object class name represents a category or a type to which an object belongs. For example, “dog” is an object class name, and “flower” is also an object class name.

Operation S603: Input the sample image and the description text into the to-be-trained model, to obtain an image predicted noise of the sample image, and input the at least two mask images and the associated object class names into the to-be-trained model, to obtain at least two object predicted noises, one object predicted noise corresponding to one mask image.

The to-be-trained model may be a model framework used for training the text-to-image model. A model structure of the to-be-trained model is not limited in some embodiments. In a possible implementation, the text-to-image model obtained through training may be a text-to-image diffusion model. Therefore, the model structure of the to-be-trained model may alternatively be an untrained diffusion model, as shown in FIG. 2 to FIG. 4.

The image predicted noise may be a predicted value obtained through predicting, by using the to-be-trained model, a noise added to the sample image, and is fitting of added noise representation. The object predicted noises may be a predicted value obtained through predicting, by using the to-be-trained model, a noise added to the mask images.

In a possible implementation, when the sample image and the description text are inputted into the to-be-trained model, and the image predicted noise of the sample image is obtained by using the to-be-trained model: first, an original image feature of the sample image is obtained by using an image encoding network, and a first text feature of the description text is obtained by using a text encoding network; then, noise addition processing is performed on the original image feature by using a noise addition network, to obtain a first noise image feature; and finally, the first noise image feature and the first text feature are inputted into a denoising network of the to-be-trained model, and noise prediction is performed by using the denoising network with reference to the first text feature and the first noise image feature, to obtain the image predicted noise of the sample image. The first text feature may be a numeric vector that is converted from the description text and can be processed by a computer device, and is configured for reflecting main content and features of the description text. The original image feature may be a numeric vector that is converted from the sample image and can be processed by a computer device, and is configured for reflecting main content and features of the sample image. The first noise image feature may be an original image feature to which a noise is added.

Similarly, when the object predicted noises associated with each mask image is obtained: first, for each mask image, a corresponding mask image-text pair is constructed, where the mask image-text pair includes a mask image and an associated object class name; then, a mask image feature of the mask image is obtained by using the image encoding network, and a second text feature of the object class name is obtained by using the text encoding network; then, noise addition processing is performed on the mask image feature by using the noise addition network, to obtain a second noise image feature; and finally, the second noise image feature and the second text feature are inputted to the denoising network, and noise prediction is performed by using the denoising network with reference to the second text feature and the second noise image feature, to obtain object predicted noises of the mask image. The second text feature may be a numeric vector that is converted from the object class name and can be processed by a computer device, and is configured for reflecting main content and features of the object class name. The mask image feature may be a numeric vector that is converted from the mask image and can be processed by a computer device, and is configured for reflecting main content and features of the mask image. The second noise image feature may be a mask image feature to which a noise is added.

In a noise addition process, the noise addition processing is performed on the entire original image feature. When the noise addition processing is performed on the mask image feature, the noise addition processing is performed on only a part of a region where the object is located. In addition, to ensure prediction accuracy, a noise added to the region where the object is located is consistent with a noise added for the image.

In a denoising process, the denoising network in some embodiments may be configured to model a relationship between text and an image. Therefore, denoising processing is performed on the image by using a denoising network layer in the denoising network and by using each text as a condition. In a denoising processing process, noise prediction is first performed, and then a predicted noise is subtracted based on a noise image feature obtained by the noise addition processing. Therefore, the predicted noise can be determined by using the denoising network.

In some embodiments, a text-to-image diffusion model is used as a text-to-image model to be trained. As the text-to-image diffusion model includes an iterative denoising process, a Gaussian noise can be converted into a sample conforming to known data distribution. In this process, the model gradually adds noise to the sample image, and gradually denoises and recovers the sample image through a reverse process, thereby generating a picture with good diversity and reality. An untrained diffusion model is used as the to-be-trained model, so that a more accurate image predicted noise and object predicted noise can be obtained. In this way, subsequently, a text-to-image model that can generate an image with good diversity and reality can be obtained through training.

In a possible implementation, the denoising network layer is a cross-attention layer included in the denoising network in the to-be-trained model. In some embodiments, the cross-attention layer is configured to model a relationship between text and an image, and a LoRA weight in the cross-attention layer may pay attention to a trainable part in the cross-attention layer. Therefore, a network parameter of the cross-attention layer is controlled by using the LoRA weight, and the denoising processing is performed on the image by using each text as a condition.

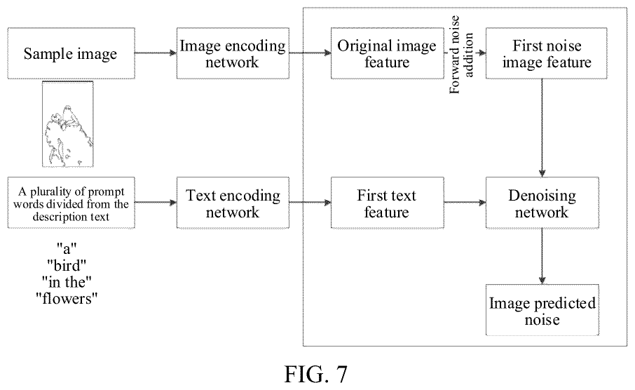

The image predicted noise is used as an example. Referring to FIG. 7, FIG. 7 is a schematic diagram of noise prediction according to some embodiments. The sample image in FIG. 7 is an image describing “a bird in the flowers”, and the description text is “a bird in the flowers”. In this case, the sample image obtains an original image feature (also referred to as a latent space vector) by using an image encoding network (VAE_encoder), the description text is divided into a plurality of prompt words, and the prompt words obtain a first text feature (also referred to as a context text vector) by using a text encoding network (CLIP). Then, forward noise addition is performed on the original image feature, to obtain a first noise image feature, and next, the first noise image feature and the first text feature are inputted into a denoising network (U-Net), to obtain an image predicted noise.

The image encoding network is also referred to as an image encoder, and the text encoding network is also referred to as a text encoder.

Operation S604: Construct a loss function based on the image predicted noise and the at least two object predicted noises, and perform parameter adjustment on the to-be-trained model based on the loss function.

In a possible implementation, when constructing the loss function based on the image predicted noise and the at least two object predicted noises: first difference information between the image predicted noise and an associated image target noise is obtained; second difference information between the object predicted noise and an associated object target noise for each of the at least two object predicted noises is obtained; and the loss function is constructed based on the first difference information and at least two pieces of second difference information.

The image target noise may be a real noise of the sample image, and may be used as a true value in a model training process. The object target noise may be a real noise of the mask image, and may be used as a true value in the model training process.

In a training process, in addition to a noise loss (for example, the first difference information) originally used and added for the sample image, a multi-object local region addition loss (for example, the second difference information) is further introduced in this application. In this way, an object is separated from another region while ensuring an image generation function of the text-to-image model, and the model is more focused on details and boundaries of objects, thereby reducing an impact of background interference on the text-to-image model, improving accuracy of the text-to-image model in a multi-object scenario, and further improving consistency and accuracy of an image generated based on the text-to-image model.

In some embodiments, the object target noise associated with each mask image is determined in the following manner: determining a first target noise of an associated mask region based on the image target noise and the mask image; then, determining a second target noise outside the mask region based on the image predicted noise and the mask image; and further, determining the object target noise associated with the mask image based on the first target noise and the second target noise. The mask region may be a part defined and distinguished by using a mask in the sample image. The first target noise may be determined by performing a cross-product calculation on the image target noise and the mask image. The second target noise may be determined by performing a cross-product calculation on the image predicted noise and an image other than the mask image.

In a implementation process, the first target noise of the associated mask region may be determined based on the image target noise ϵ and the mask image m, for example, the first target noise is ϵ⊗m. The second target noise outside the mask region may be determined based on the image predicted noise ϵ_{θ} and the mask image m, for example, the second target noise is ϵ_{θ}⊗(1−m). The object target noise associated with the mask image is determined based on the first target noise and the second target noise. Therefore, an object mask noise \tilde{ϵ}=ϵ⊗m+ϵ_{θ}⊗(1−m).

In conclusion, the loss function constructed in some embodiments is:

$${L}_{SP} = {\sum }_{i ∈ S} {‖ {\tilde{ϵ}}_{i} - {ϵ}_{θ} ( {\tilde{z}}_{t , i} , t , {c}_{m , i} ) ‖}_{2}^{2} + {‖ ϵ - {ϵ}_{θ} ( {z}_{t} t , c ) ‖}_{2}^{2}$$

In the function, \tilde{ϵ}ᵢ (is the object target noise associated with the mask image, c_{m,i} is the object class name associated with the mask image, \tilde{z}_{i,j} is latent representation of the mask image, where \tilde{z}_{i,j}=z⊗m, and i is a quantity of mask images, where i=1, 2, . . . , S.

In the foregoing manner, the loss function is jointly determined with reference to a loss in the mask region and a loss outside the mask region, so that the object can be separated from another region. In this way, the model pays more attention to details and boundaries of objects, thereby reducing an impact of background interference on the text-to-image model, improving accuracy of the text-to-image model in the multi-object scenario, and further improving consistency and accuracy of generating an image based on the text-to-image model.

In a possible implementation, when parameter adjustment is performed on the to-be-trained model by using the loss function, parameter adjustment is performed on a text encoder in the to-be-trained model based on the loss function, and a low-rank adaptive weight on each attention linear layer in the denoising network in the to-trained model is adjusted.

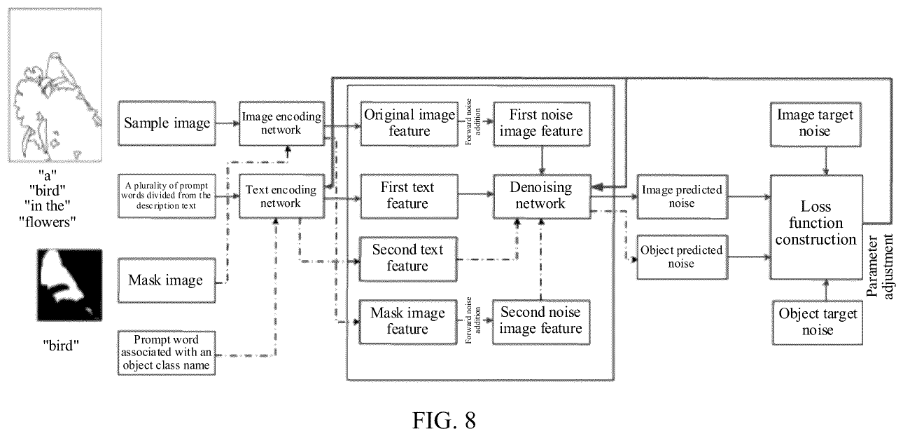

Referring to FIG. 8, FIG. 8 is a schematic diagram of text-to-image model training according to some embodiments. Based on FIG. 8, a sample image and description text are inputted into a to-be-trained model, to obtain an image predicted noise of the sample image; and at least two mask images and associated object class names are inputted into the to-be-trained model, to obtain object predicted noises respectively associated with the at least two mask images. A loss function is constructed based on the image predicted noise, an image target noise, the at least two object predicted noises and associated object target noises, and is configured for inversely adjusting a parameter in the to-be-trained model.

Some embodiments respectively performs parameter adjustment on a network of each part in the to-be-trained model, and parameter adjustment can be independently performed on each part of the network. In this way, module independence is improved, and parameter adjustment can be performed on each part of the network in parallel, thereby improving parameter adjustment efficiency and reducing a calculation resource requirement.

After training of a batch is completed, an iteration process ends. In some embodiments, before model parameter adjustment is performed, whether a model convergence condition is satisfied may further be determined. For example, the model convergence condition may include at least one of the following conditions: a model loss is not greater than a preset loss value threshold; and a quantity of iteration times reaches a preset upper limit value of a quantity of times.

In this application, as the input information includes the sample image and the description text, and the sample image includes at least two objects, the to-be-trained model is enabled to learn a multi-object scenario, so that the to-be-trained model can process the complex multi-object scenario, thereby improving a multi-object generation capability. The input information further sets the mask image and the associated object class name; the mask image is configured for distinguishing a location region of the object in the sample image, to distinguish the object from a background, to prevent background information from causing interference to model training, and to obtain a correspondence relationship between the mask image and the object class name, which helps to enhance an object relationship between the object and text, so that in a model training process, text description can be better understood and accurately mapped to a corresponding object, thereby ensuring accuracy of the to-be-trained model. In addition, a multi-object local region addition loss is also introduced, and the loss separates the object from another region, so that the model focuses more on details and boundaries of objects, thereby reducing an impact of background interference on the to-be-trained model, improving accuracy of the text-to-image model in the multi-object scenario, and further improving consistency and accuracy of an image generated based on the to-be-trained model.

### Embodiment 2: Model Application Process

In a possible implementation, an image corresponding to specified text may further be generated by using a text-to-image model obtained through model training. Specifically, first, the specified text inputted by a target object is obtained, the specified text including at least two target class names; and then, based on the specified text, by using the text-to-image model, and with reference to historical reference objects respectively associated with the at least two target class names, the image corresponding to the specified text is obtained.

In some embodiments, an inputting manner of the specified text includes, but is not limited to, voice, text, or the like. If the target object inputs the specified text by voice, inputted voice information may be converted into the specified text by using a voice technology. A target class name may be an object class name inputted by a user and of an object expected to be included in a generated image.

In some embodiments, when based on the specified text, by using the text-to-image model, and with reference to historical reference objects respectively associated with the at least two target class names, the image corresponding to the specified text is obtained: first, word segmentation is performed on the specified text, to obtain at least one keyword included in the specified text, the at least one keyword including all target class names in the specified text; and then, the obtained at least one keyword is inputted into the text-to-image model, and by using the text-to-image model and with reference to historical reference objects respectively associated with the at least two target class names, the image corresponding to the specified text is obtained. In some embodiments, an extraction manner of keywords is not limited.

In some embodiments, the text-to-image model may generate a plurality of candidate images for the specified text. When the plurality of candidate images are generated, based on aesthetic evaluation information respectively corresponding to the candidate images, in descending order of values of at least one candidate generated image, the first top K candidate generated images are used as the image.

The aesthetic evaluation information is determined by using an aesthetic evaluation model. In addition, when a plurality of candidate images are included, a quantity of images may be one or multiple, which is not limited.

In a possible implementation, before the specified text is inputted into the text-to-image model, it is determined that an image-text sample pair training set and historical reference images include the historical reference objects respectively associated with the at least two target class names.

In another possible implementation, before the specified text is inputted into the text-to-image model, and when it is determined that the image-text sample pair training set and the historical reference images do not include the historical reference objects respectively associated with the at least two target class names, an image including a reference object associated with the target class name and the specified text are inputted into the text-to-image model. By using the text-to-image model, based on the specified text, and with reference to reference objects respectively associated with the at least two target class names in the image, the image corresponding to the specified text is obtained.

By determining whether the image-text sample pair training set and the historical reference images include the historical reference objects respectively associated with the at least two target class names, the most appropriate manner is selected to generate the image corresponding to the specified text, thereby ensuring accuracy of image generation.

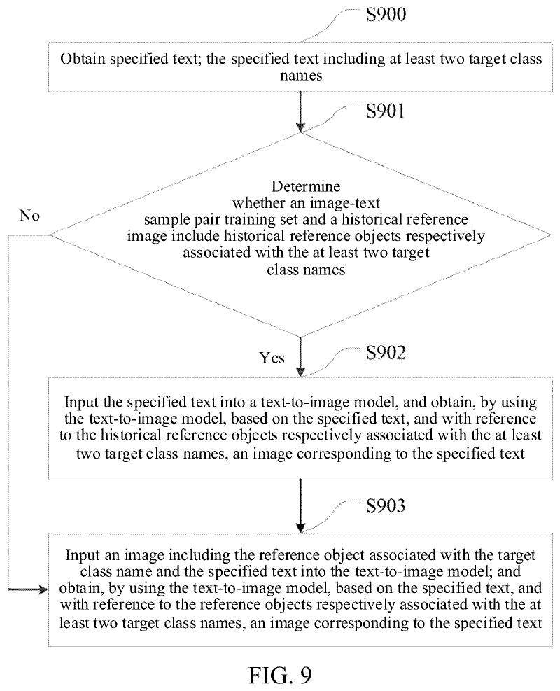

The following uses an example in which a server performs the method independently, to describe an implementation of generating an image based on the text-to-image model obtained by using the foregoing model training method. Referring to FIG. 9, FIG. 9 is a method flowchart of image generation according to some embodiments, including the following operations:

Operation S900: Obtain specified text, the specified text including at least two target class names.

Operation S901: Determine whether an image-text sample pair training set and a historical reference image include historical reference objects respectively associated with the at least two target class names; if yes, perform operation S902; otherwise, perform operation S903.

Operation S902: Input the specified text into a text-to-image model, and obtain, by using the text-to-image model, based on the specified text, and with reference to the historical reference objects respectively associated with the at least two target class names, an image corresponding to the specified text.

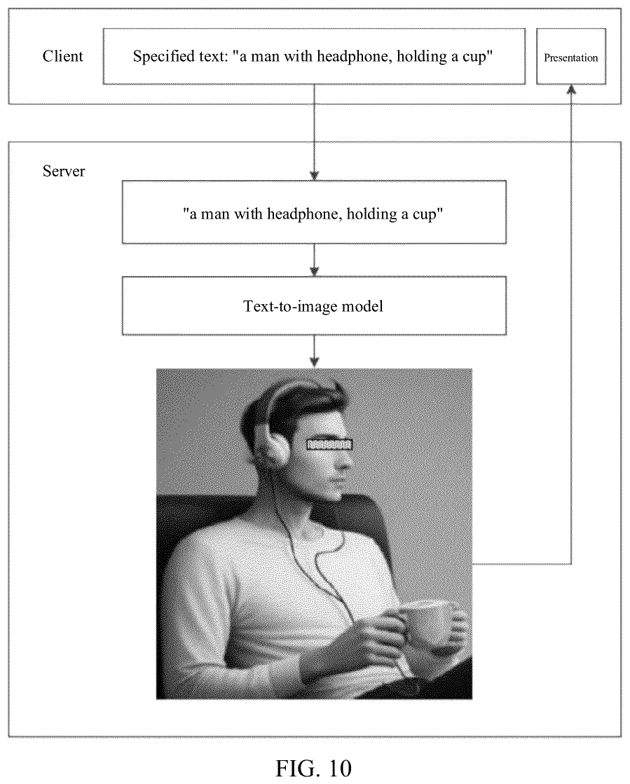

Referring to FIG. 10, FIG. 10 is a schematic diagram of image generation based on a text-to-image model according to some embodiments. Based on FIG. 10, a server obtains, by using a client, specified text of at least two target class names inputted by an object (for example, a user), the specified text being: “a man with headphone, holding a cup”. Then, when it is determined that an image-text sample pair training set and a historical reference image include: a historical reference object associated with a target class name (“headphone”), a historical reference object associated with a target class name (“cup”), and a historical reference object associated with a target class name (“man”), the server inputs the specified text into a text-to-image model, to obtain an image corresponding to the specified text. Then, the server returns the generated image to the client for presentation.

Operation S903: Input an image including the reference object associated with the target class name and the specified text into the text-to-image model; and obtain, by using the text-to-image model, based on the specified text, and with reference to the reference objects respectively associated with the at least two target class names, an image corresponding to the specified text.

In a possible implementation, if the image-text sample pair training set and the historical reference image do not include reference objects associated with all target class names in the specified text, an image may be obtained. The image includes at least an object that appears in the specified text but does not appear in the image-text sample pair training set and the historical reference image. Then, image prediction is performed based on the image and the specified text.

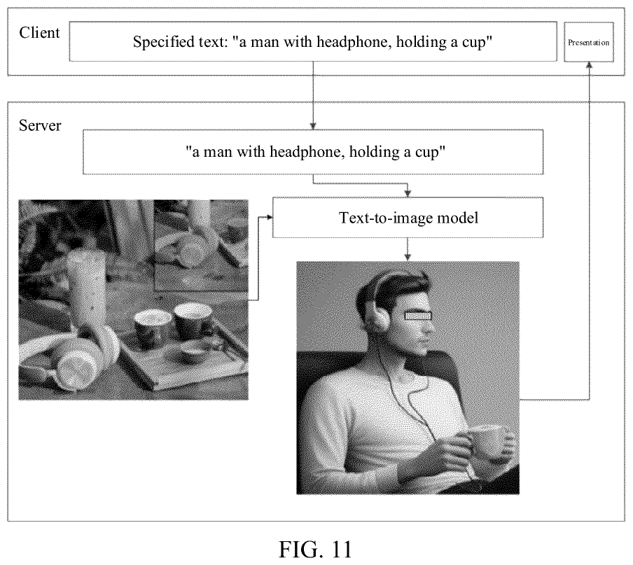

Referring to FIG. 11, FIG. 11 is a schematic diagram of image generation based on a text-to-image model according to some embodiments. Based on FIG. 11, a server obtains, by using a client, specified text of at least two target class names inputted by an object, the specified text being: “a man with headphone, holding a cup”. Then, when it is determined that an image-text sample pair training set and a historical reference image do not include: a historical reference object associated with a target class name (“headphone”) and a historical reference object associated with a target class name (“cup”), a target reference image including both the “cup” and the “headphone” is obtained, and the target reference image including both the “cup” and the “headphone” is inputted into the text-to-image model. By using the text-to-image model, based on the specified text, and with reference to the reference object associated with the “cup” in the image and the reference object associated with the “headphone” in the image, an image corresponding to the specified text is obtained. Then, the server returns the generated image to the client for presentation.

In this application, as input data and a loss function are improved in a training process, the text-to-image model can be applied to a multi-object scenario, and accuracy of the text-to-image model may be ensured. Therefore, an image including a plurality of objects can be accurately obtained based on the text-to-image model, and consistency and accuracy of the image are improved.

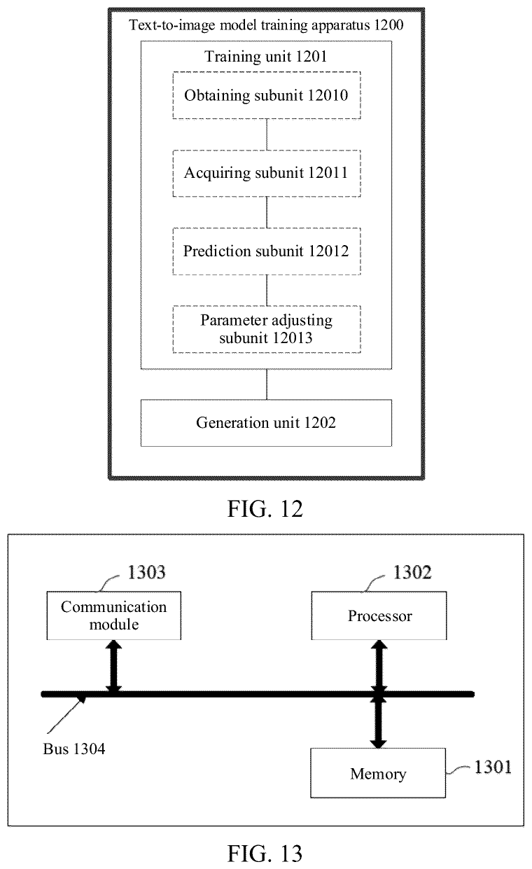

Based on a same inventive concept, some embodiments further provides a text-to-image model training apparatus. As shown in FIG. 12, the text-to-image model training apparatus 1200 includes:
a training unit 1201, the training unit 1201 including: an obtaining subunit 12010, an acquiring subunit 12011, a prediction subunit 12012, and a parameter adjusting subunit 12013. Among subunits:

The training unit 1201 is configured to perform, based on an image-text sample pair training set, cyclic iterative training on a to-be-trained model, to obtain a text-to-image model. In a cyclic iteration process, corresponding operations are performed by using the following subunits:
the obtaining subunit 12010, configured to select an image-text sample pair from the image-text sample pair training set, the image-text sample pair including a sample image and description text of the sample image, and the sample image including at least two objects;
the acquiring subunit 12011, configured to obtain mask images and associated object class names respectively corresponding to the at least two objects, the mask images being configured for distinguishing location regions of corresponding objects in the sample image;
the prediction subunit 12012, configured to input the sample image and the description text into the to-be-trained model, to obtain an image predicted noise of the sample image, and input the at least two mask images and the associated object class names into the to-be-trained model, to obtain at least two object predicted noises respectively associated with the at least two mask images; and
the parameter adjusting subunit 12013, configured to construct a loss function based on the image predicted noise and the at least two object predicted noises, and perform parameter adjustment on the to-be-trained model based on the loss function.

In a possible implementation, the prediction subunit 12012 uses the to-be-trained model to perform the following operations:
obtaining an original image feature of the sample image and a first text feature of the description text;
performing noise addition processing on the original image feature, to obtain a first noise image feature; and
performing noise prediction by using a denoising network in the to-be-trained model with reference to the first text feature and the first noise image feature, to obtain the image predicted noise of the sample image.

In a possible implementation, the prediction subunit 12012 is configured to:
respectively construct a corresponding mask image-text pair for each mask image of the at least two mask images, the mask image-text pair including a mask image and an associated object class name; and
performing the following operations on the mask image-text pair by using the to-be-trained model:
obtaining a mask image feature of the mask image and a second text feature of the object class name;
performing noise addition processing on the mask image feature, to obtain a second noise image feature; and
performing noise prediction by using the denoising network in the to-be-trained model with reference to the second text feature and the second noise image feature, to obtain the object predicted noise of the mask image.

In a possible implementation, the parameter adjusting subunit 12013 is configured to:
obtain first difference information between the image predicted noise and an associated image target noise;
respectively obtain, for each of the at least two object predicted noises, second difference information between the object predicted noise and an associated object target noise; and
construct the loss function based on the first difference information and at least two pieces of the second difference information.

In a possible implementation, an object target noise associated with each mask image is determined in the following manner:
determining, based on the image target noise and the mask image, a first target noise of an associated mask region;
determining, based on the image predicted noise and the mask image, a second target noise outside the mask region; and
determining, based on the first target noise and the second target noise, the object target noise associated with the mask image.

In a possible implementation, the parameter adjusting subunit 12013 is configured to:
adjust a text encoder in the to-be-trained model based on the loss function; and
adjust a low-rank adaptive weight on each attention linear layer in the denoising network in the to-be-trained model.

In a possible implementation, the apparatus further includes a generation unit 1202, the generation unit 1202 being configured to:
obtain specified text, the specified text including at least two target class names; and
obtain, by using the text-to-image model, based on the specified text, and with reference to historical reference objects respectively associated with the at least two target class names, an image corresponding to the specified text.

In a possible implementation, the generation unit 1202 is further configured to:
determine, before the specified text is inputted into the text-to-image model, that an image-text sample pair training set and historical reference images include the historical reference objects respectively associated with the at least two target class names.

Although several units or modules of the apparatus are mentioned in the above detailed description, such division is merely exemplary and not mandatory. In fact, the features and functions of two or more units or modules described above may be embodied in a single unit or module, depending on the implementations of this application. Similarly, the features and functions of one unit or module described above may be further divided and embodied in a plurality of units or modules. Certainly, during implementation of this application, the functions of each unit or module may be implemented in a same piece of or a plurality of pieces of software or hardware.

After the text-to-image model training method and apparatus in the exemplary implementations of this application are introduced, a computing device in another exemplary implementation of this application is introduced below.

A person skilled in the art can understand that the aspects of this application may be implemented as systems, methods, or program products. Therefore, the aspects of this application may be embodied in the following forms: a hardware-only implementation, a software-only implementation (including firmware, microcode, and the like), or an implementation using a combination of hardware and software, which may be collectively referred to herein as “circuit”, “module”, or “system”.

In a possible implementation, the computing device provided in some embodiments may include at least a processor and a memory. The memory stores program codes. When the program codes are executed by the processor, the processor is made to perform any operation in the text-to-image model training method in various exemplary implementations in this application.

In some embodiments, a structure of the computing device may be shown in FIG. 13, including a memory 1301, a communication module 1303, and one or more processors 1302.

The memory 1301 is configured to store a computer program executed by a processor 1302. The memory 1301 may mainly include a program storage area and a data storage area. The program storage area may store an operating system, a program to run an instant messaging function, and the like. The data storage area may store various instant messages, operation instruction sets, and the like.

The memory 1301 may be a volatile memory such as a random-access memory (RAM). In some embodiments, the memory 1301 may be a non-volatile memory such as a read-only memory, a flash memory, a hard disk drive (HDD), or a solid-state drive (SSD). In some embodiments, the memory 1301 is any other medium that can be used to carry or store an expected computer program that has an instruction or data structure form and can be accessed by a computer, but is not limited thereto. The memory 1301 may be a combination of the foregoing memories.

The processor 1302 may include one or more central processing units (CPUs) or be a digital processing unit, or the like. The processor 1302 is configured to call the computer program stored in the memory 1301, to implement the foregoing text-to-image model training method.

The communication module 1303 is configured to communicate with a terminal device and another server.

A connection medium between the foregoing memory 1301, the communication module 1303, and the memory 1302 is not limited in some embodiments. In some embodiments, in FIG. 13, the memory 1301 is connected to the processor 1302 by a bus 1304, and the bus 1304 is described with a thick line. Connection modes between other components are only for schematic illustration and are not used for a limitation. The bus 1304 may be classified into an address bus, a data bus, a control bus, and the like. For ease of description, only one thick line is used in FIG. 13 for description, but there is no description of only one bus or one type of bus.

The memory 1301 stores a computer storage medium. The computer storage medium stores a computer program. The computer program is configured for implementing the text-to-image model training method in some embodiments. The processor 1302 is configured to perform the foregoing text-to-image model training method.

In a implementation of this application, user-related data is involved. When foregoing embodiments of this application are applied to a product or technology, user permission or consent may be obtained, and collection, use, and processing of related data are obtained to comply with relevant laws, regulations, and standards of relevant countries and regions.

In some possible implementations, various aspects of the text-to-image model training method provided in this application may also be embodied in the form of a program product, which includes a computer program. When the computer program is executed on a computing device, the computer program is configured for causing the computing device to execute the foregoing operations in the text-to-image model training method according to various exemplary implementations in this application as described in this specification.

The program product may use a readable medium or any combination of more readable media. The readable medium may be a readable signal medium or a readable storage medium. The readable storage medium may be, for example, but is not limited to, an electric, magnetic, optical, electromagnetic, infrared, or semiconductor system, apparatus, or device, or any combination thereof. More examples of the readable storage medium (a non-exhaustive list) include: an electrical connection having one or more wires, a portable disk, a hard disk, a RAM, a ROM, an erasable programmable ROM (EPROM or a flash memory), an optical fiber, a compact disc ROM (CD-ROM), an optical storage device, a magnetic storage device, or any appropriate combination thereof.

The program product according to embodiments of this application may use a portable compact disc read-only memory (CD-ROM) and include program codes, and may be run on a computing apparatus. However, the program product of this application is not limited thereto. Herein, the readable storage medium may be any tangible medium containing or storing a program, and the program may be used by or in combination with a command execution system, an apparatus, or a device.

The readable signal medium may include a data signal propagated in a baseband or as a part of a carrier, which carries readable program codes. A data signal propagated in such a way may assume a plurality of forms, including, but not limited to, an electromagnetic signal, an optical signal, or any appropriate combination thereof. The readable signal medium may also be any readable medium other than the readable storage medium. The readable medium may send, propagate, or transmit a program that is used by or used in combination with an instruction execution system, an apparatus or a device.

The program codes included on the readable medium may be transmitted in any appropriate medium, including, but not limited to a wireless medium, a wired medium, an optical cable, radio frequency (RF), and the like, or any appropriate combination thereof.

Program codes for performing operations of this application may be written in one or any combination of more programming languages. The programming languages include target-oriented programming languages, such as Java and C++, and further include procedural programming languages, such as the C programming language or similar programming languages. The program codes may be completely executed on a user computing apparatus, partially executed on a user device, executed as an independent software package, partially executed on the user computing apparatus and partially executed on a remote computing apparatus, or completely executed on the remote computing apparatus or a server. In a situation involving the remote computing apparatus, the remote computing apparatus may be connected to the user computing apparatus through any type of network including an LAN or a WAN, or may be connected to an external computing apparatus (for example, connected to the external computing apparatus through the Internet by using an Internet service provider).

A person skilled in the art may understand that embodiments of this application may be provided as a method, a system, or a computer program product. Therefore, this application may use a form of a hardware-only embodiment, a software-only embodiment, or an embodiment with a combination of software and hardware. In addition, this application may use a form of a computer program product implemented on one or more computer-available storage media (including, but not limited to a disk memory, a CD-ROM, an optical memory, and the like) that include computer-available program codes.

This application is described with reference to flowcharts and/or block diagrams of the method, the device (system), and the computer program product in some embodiments. Computer program instructions may be used to implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable device to generate a machine, so that an apparatus configured to implement functions specified in one or more procedures in the flowcharts and/or one or more blocks in the block diagrams is generated by using instructions executed by the general-purpose computer or the processor of the another programmable device.

These computer program instructions may also be stored in a computer readable memory that can guide a computer or another programmable device to operate in a manner, so that the instructions stored in the computer readable memory generate a product including an instruction apparatus, where the instruction apparatus implements functions specified in one or more procedures in the flowcharts and/or one or more blocks in the block diagrams.

These computer program instructions may also be loaded into a computer or another programmable device, so that a series of operations are performed on the computer or another programmable device, to generate processing implemented by a computer, and instructions executed on the computer or another programmable device provide operations for implementing functions specified in one or more procedures in the flowcharts and/or one or more blocks in the block diagrams.

Although preferred embodiments of this application have been described, persons skilled in the art can make changes and modifications to these embodiments once they learn the inventive concept. Therefore, the following appended claims are intended to be construed as encompassing the preferred embodiments and all changes and modifications falling within the scope of this application.

Clearly, a person skilled in the art can make various modifications and variations to this application without departing from the spirit and scope of this application. In this case, if the modifications and variations made to this application fall within the scope of the claims of this application and equivalent technologies thereof, this application is intended to include these modifications and variations.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A text-to-image model training method, performed by a computing device, comprising training a text-to-image model by performing cyclic iterative training using a training set comprising sample image and text pairs,
wherein the cyclic iterative training comprises:
selecting an image-text sample pair from the training set, the image-text sample pair comprising a sample image and description text of the sample image, and the sample image including at least two objects;
obtaining at least two mask images and at least two object class names corresponding to the at least two objects, the mask images being configured to distinguish location regions of the at least two objects;
inputting the sample image and the description text into the text-to-image model to obtain an image predicted noise of the sample image;
inputting the at least two mask images and the at least two object class names into the text-to-image model to obtain at least two object predicted noises corresponding to the mask images;
constructing a loss function based on the image predicted noise and the at least two object predicted noises; and
performing parameter adjustment on the text-to-image model based on the loss function.

2. The method according to claim 1, wherein the inputting the sample image and the description text comprises:
obtaining an original image feature of the sample image and a first text feature of the description text;
performing noise addition on the original image feature to obtain a first noise image feature; and
performing noise prediction with a denoising network in the text-to-image model based on the first text feature and the first noise image feature, to obtain the image predicted noise of the sample image.

3. The method according to claim 1, wherein the inputting the at least two mask images comprises:
constructing a mask image-text pair for each of the at least two mask images, the mask image-text pair comprising a mask image and an object class name; and
performing the following operations on the mask image-text pair by using the to-be-trained model:
obtaining a mask image feature of the mask image and a second text feature of the object class name mask image-text pair with the text-to-image model;
performing noise addition with the text-to-image model on the mask image feature to obtain a second noise image feature; and
performing noise prediction with the denoising network in the text-to-image model based on the second text feature and the second noise image feature to obtain the object predicted noise of the mask image.

4. The method according to claim 1,
wherein the constructing a loss function comprises:
obtaining first difference information between the image predicted noise and an image target noise;
obtaining, for each of the at least two object predicted noises, second difference information between the object predicted noise and an object target noise; and
constructing the loss function based on the first difference information and the second difference information.

5. The method according to claim 4, wherein an object target noise is determined by:
determining, based on the image target noise and the mask image, a first target noise of a mask region;
determining, based on the image predicted noise and the mask image, a second target noise outside the mask region; and
determining, based on the first target noise and the second target noise, the object target noise.

6. The method according to claim 1, wherein the performing parameter adjustment comprises:
performing parameter adjustment on a text encoder in the text-to-image model based on the loss function; and
adjusting a low-rank adaptive weight on each attention linear layer in the denoising network in the text-to-image model.

7. The method according to claim 1, further comprising:
obtaining specified text comprising at least two target class names; and
generating an image corresponding to the specified text using the text-to-image model, based on the historical reference objects associated with the at least two target class names.

8. The method according to claim 7, the method further comprises:
determining that the training set and a historical reference image comprise the historical reference objects associated with the at least two target class names.

9. A text-to-image model training apparatus, comprising:
at least one memory configured to store program code; and
at least one processor configured to read the program code and operate as instructed by the program code, the program code comprising:
training code configured to cause at least one of the at least one processor to train a text-to-image model by performing cyclic iterative training using a training set comprising sample image and text pairs,
wherein the cyclic iterative training comprises:
selecting code configured to cause at least one of the at least one processor to select an image-text sample pair from the training set, the image-text sample pair comprising a sample image and description text of the sample image, and the sample image including at least two objects;
obtaining code configured to cause at least one of the at least one processor to obtain at least two mask images and at least two object class names corresponding to the at least two objects, the mask images being configured to distinguish location regions of the at least two objects;
input code configured to cause at least one of the at least one processor to input the sample image and the description text into the text-to-image model to obtain an image predicted noise of the sample image;
mask code configured to cause at least one of the at least one processor to input the at least two mask images and the at least two object class names into the text-to-image model to obtain at least two object predicted noises corresponding to the mask images;
construction code configured to cause at least one of the at least one processor to construct a loss function based on the image predicted noise and the at least two object predicted noises; and
adjustment code configured to cause at least one of the at least one processor to perform parameter adjustment on the text-to-image model based on the loss function.

10. The apparatus according to claim 9, wherein the input code is further configured to cause at least one of the at least one processor to:
obtain an original image feature of the sample image and a first text feature of the description text;
perform noise addition on the original image feature to obtain a first noise image feature; and
perform noise prediction with a denoising network in the text-to-image model based on the first text feature and the first noise image feature, to obtain the image predicted noise of the sample image.

11. The apparatus according to claim 9, wherein the mask code is further configured to cause at least one of the at least one processor to:
construct a mask image-text pair for each of the at least two mask images, the mask image-text pair comprising a mask image and an object class name; and
perform the following operations on the mask image-text pair by using the to-be-trained model:
obtain a mask image feature of the mask image and a second text feature of the object class name mask image-text pair with the text-to-image model;
perform noise addition with the text-to-image model on the mask image feature to obtain a second noise image feature; and
perform noise prediction with the denoising network in the text-to-image model based on the second text feature and the second noise image feature to obtain the object predicted noise of the mask image.

12. The apparatus according to claim 9,
wherein the construction code is further configured to cause at least one of the at least one processor to:
obtain first difference information between the image predicted noise and an image target noise;
obtain, for each of the at least two object predicted noises, second difference information between the object predicted noise and an object target noise; and
construct the loss function based on the first difference information and the second difference information.

13. The apparatus according to claim 12, wherein an object target noise is determined by:
determining, based on the image target noise and the mask image, a first target noise of a mask region;
determining, based on the image predicted noise and the mask image, a second target noise outside the mask region; and
determining, based on the first target noise and the second target noise, the object target noise.

14. The apparatus according to claim 9, wherein the adjustment code is further configured to cause at least one of the at least one processor to:
perform parameter adjustment on a text encoder in the text-to-image model based on the loss function; and
adjust a low-rank adaptive weight on each attention linear layer in the denoising network in the text-to-image model.

15. The apparatus according to claim 9, wherein the program code further comprises:
text code configured to cause at least one of the at least one processor to obtain specified text comprising at least two target class names; and
generation code configured to cause at least one of the at least one processor to generate an image corresponding to the specified text using the text-to-image model, based on the historical reference objects associated with the at least two target class names.

16. The apparatus according to claim 15, wherein the program code further comprises:
determination code configured to cause at least one of the at least one processor to determine that the training set and a historical reference image comprise the historical reference objects associated with the at least two target class names.

17. A non-transitory computer-readable storage medium, storing computer code which, when executed by at least one processor, causes the at least one processor to at least:
train a text-to-image model by performing cyclic iterative training using a training set comprising sample image and text pairs,
wherein the cyclic iterative training comprises:
select an image-text sample pair from the training set, the image-text sample pair comprising a sample image and description text of the sample image, and the sample image including at least two objects;
obtain at least two mask images and at least two object class names corresponding to the at least two objects, the mask images being configured to distinguish location regions of the at least two objects;
input the sample image and the description text into the text-to-image model to obtain an image predicted noise of the sample image;
input the at least two mask images and the at least two object class names into the text-to-image model to obtain at least two object predicted noises corresponding to the mask images;
construct a loss function based on the image predicted noise and the at least two object predicted noises; and
perform parameter adjustment on the text-to-image model based on the loss function.
